(19) United States
(12) Patent Application Publication
(10) Pub. No.: US 2018/0202554 A1
(43) Pub. Date: Jul. 19, 2018

(54) BI-DIRECTIONAL SEALING SYSTEM FOR THE OUTLET OF A PLASTIC-LINED COMPRESSED GAS CYLINDER

(71) Applicant: Hansho Composites, LLC, Wheatland, WY (US)

(72) Inventor: Shaun Hogan, Westford, MA (US)

(21) Appl. No.: 15/746,430

(22) PCT Filed: Jul. 22, 2016
(86) PCT No.: PCT/US16/43493

§ 371 Date: Jan. 22, 2018

Related U.S. Application Data
(60) Provisional application No. 62/195,744, filed on Jul. 22, 2015.

(51) Int. Cl. F16J 15/10; F16J 12/00; F17C 1/16; F17C 13/06

(52) U.S. Cl. CPC F16J 15/10; F17C 2203/0673; F17C 1/16; F17C 13/06; F17C 2221/033; F17C 2221/035; F17C 2221/012; F17C 2221/017; F17C 2221/031; F17C 2221/014; F17C 2201/0109; F17C 2203/0604; F17C 2203/0619; F17C 2203/066; F17C 2205/0305; F16J 12/00

(57) ABSTRACT

A sealing system for an outlet of a polymer-lined compressed gas cylinder has a polymer liner outlet extending into a bore of a boss. An insert is engaged with the bore and a secondary angled seal, forming two primary seals between the insert and portion of the liner outlet. The first seal is an O-ring in the radial direction. The second seal is an angled seal, or beveled conical seal, of the polymer being compressed between the metal components of polar boss and the insert. The use of seal in two different directions compresses the polymer liner in two directions to prevent any possibility of gas leakage and/or seal extrusion under pressure. The angled seal surface prevents any reverse extrusion of the primary seal that might happen during cold temperatures or during repeated pressure cycles in long term service.

### CROSS-REFERENCE TO RELATED APPLICATION

This application claims priority to U.S. Provisional Patent Application Ser. No. 62/195,744 to Shaun Hogan for a Bi-Directional Sealing System for the Outlet of a Plastic-Lined Compressed Gas Cylinder filed on Jul. 22, 2015, the contents of which are incorporated herein by reference in its entirety.

### FIELD

The present invention relates to a design of attaching metallic end fittings, known as polar bosses, to a polymer liner of fiber-wrapped compressed gas cylinders. More particularly, the present disclosure relates to a bi-directional sealing method that prevents leakage, anti-extrusion, and avoids problems of long-term permanent compression creep and extrusion of conventional O-ring seals at a sealing interface.

### BACKGROUND

Fiber reinforced composite pressure vessels for high-pressure gases are designed and built to provide lightweight, safe gas containment. These composite gas cylinders are used for storing high-pressure gases such as air, nitrogen, carbon dioxide (CO2), liquefied petroleum gas (LPG), compressed natural gas (CNG), and hydrogen.

Full-wrapped composite gas cylinders contain high-pressure gases through the use of impermeable liners made of either a metal or polymer. The liners are reinforced over their full surface with high strength structural fibers. The structural fibers provide necessary strength and toughness. The liners are designed to contain gases without leaks or permeation.

Polymer lined composite cylinders are built with one or more metallic end openings, known as a polar boss, for connecting valves, pressure fittings, and other equipment for filling and discharging gas into the cylinders. These polar bosses are located in domed ends centered on a longitudinal axis of the composite cylinders. Typically, a metal polar boss is installed onto the polymer liner prior to wrapping with structural fibers, and the boss has a flange, or partial shoulder, that is over-wrapped with the structural fibers. The boss provides an opening to the cylinder interior and is built with screw threads that will fit to pressure fittings, plugs, valves, or a pressure regulator.

A major challenge with composite cylinder design is to create an infallible no-leak pressure seal between the polymer liners and metal polar bosses. This is particularly challenging considering that the seal must prevent leaks for 15 to 20 years of the cylinder service life. The polymer liners must not crack or permanently deform when exposed to temperatures ranging from −50 to 85 C and repeated pressure cycles from zero to 1.5 times working pressure. Finally, the pressure seal must not allow leakage or permeation of small molecule gases like hydrogen and helium at high pressures.

Engineering polymers and thermoplastics are notoriously difficult to work with in long-term applications. Welding to the metal polar boss is impossible. Adhesive bonds are extremely difficult, particularly for 20-year service life where thermal expansions of metal and plastic are quite different. Consequently, most plastic-lined composite cylinders use a compression seal approach that compresses the plastic liner between two metal components.

Historically, leakage through the liner/polar boss interface has occurred due to several problems. Some reasons include differential shrinkage rates between the metal and polymer due to rapid heating and cooling during fast pressurization and discharging. O-ring seals have extruded during pressure cycling or from improper installation or maintenance. In other cases, the polymer liner became de-bonded and delaminated away from the metal polar boss.

Polar boss designs for composite gas cylinders fall into two categories: 1) adhesive bonded seals, where the polymer liner is permanently bonded to the metal polar boss, and 2) mechanical compression seals where the polymer liner is compressed between two metal components to create permanent seals. This current invention falls into category 2, mechanical compression sealing.

Examples of cylinders with adhesive bonded seals are set forth in U.S. Pat. No. 5,518,141 to Newhouse et al. and U.S. Pat. No. 5,979,692 to Bill West. When a leak does occur, the cylinder cannot be repaired and is scrap.

Examples of cylinders with mechanical compression seals are set forth in U.S. Pat. No. 5,938209 to Siroshi, et al., U.S. Pat. No. 6,230,922 to Rasche, et al., and U.S. Pat. No. 6,186,356 to Berkley et al, and U.S. Pat. Pub. No. 2011/0210516 by Sharp et al.

Other prior art arrangements include combining adhesive bonding between the polymer liner and metal polar boss, combined with mechanical compression to prevent delaminations. Examples of these include U.S. Pat. No. 7,549,555 to Suzuki et al, and U.S. Pat. Application 20070164561 to Kwon.

A characteristic of polymer is a high rate of creep under sustained loading. In sustained tension, a polymer will lengthen permanently. In sustained compression, it will shrink permanently. In the case of the polar boss seal for composite pressure vessels, creep is exhibited as permanent compression shrinkage at the seal interface of the liner and the insert. Seals typically comprise an elastomeric seal element compressed against a rigid seat. With the introduction of polymer liners, the rigid seat is replaced with the polymer material. Over time, polymer tends to slowly compress permanently to smaller size, when can then allow pressurized gases to escape.

It is known in the art to introduce a liner outlet into the bore of the boss. Accordingly, there has been an attempt to provide a seal between the polymer liner within the boss and the insert. In U.S. Pat. No. 5,938,209 to Sirosh et al. and U.S. Pat. No. 6,186,356 to Berkley et al., an O-ring is sandwiched axially between an annular end face of the liner and end face of the insert. In another form, as set forth in published U.S. Pat. Pub. No. 2009/0071930 to Sato et al., an O-ring is located between the liner and the boss. Again, should a leak occur, the cylinder cannot be repaired and is scrap.

Other factors contributing to seal leakage include differential thermal expansion of the differing materials. The insert is usually aluminum or stainless steel, which has a lower coefficient of thermal expansion than polymer, which can also cause issues at the interface.

Other prior art arrangements overcome these limitations by combining adhesive bonding between the polymer liner and metal polar boss, accompanied with mechanical compression to prevent delaminations. Examples of these include U.S. Pat. No. 7,549,555 to Suzuki et al, and U.S. Pat. Application 20070164561 to Kwon. The problem with these methods is that the pressure vessel must be opened to gain access to the mechanical seal. If there is any problem with the mechanical seal or adhesive bond, the cylinder must be scrapped.

The current invention resolves the problems of many prior art methods. A new two-directional sealing system is created that provides an impermeable pressure seal with or without the annular O-ring.

### SUMMARY

Embodiments described herein are directed to a two-directional sealing system formed between an outlet of a polymer liner extending into a bore of a metallic fitting known as a polar boss. The liner outlet and the bore of the polar boss form a profiled bore and also an angled conical compression area. An insert, engageable with the profiled bore, forms a two-location pressure seal system.

The first pressure seal is in the radial direction, located in the profiled bore of the polar boss. The second pressure seal forms an angular compression between a conical section of the polar boss and a matching conical section of the insert. The resulting bidirectional compression seal system forms an infallible, long term seal between the polymer liner and metallic polar boss.

The bidirectional compression sealing system enables sealing in two directions, thus preventing extrusion of the seal elements. This bidirectional sealing system will continue to seal pressure in case of O-ring seal malfunction. This sealing system eliminates against the effects of permanent compression creep, thermal expansion due to high and low temperature extremes, and other problems commonly encountered with polymer lined composite pressure vessels.

Accordingly, in one broad aspect a sealing system for an outlet of a polymer-lined compressed gas cylinder is provided. The polymer-lined cylinder comprises a polymer liner, a metallic end fitting known as a polar boss, and a screw-in or otherwise engageable metallic insert known as the pressure insert.

The polymer liner has an annular neck which transitions to a conical or bevel shaped neck. Standard molding procedures; rotational molding, blow molding, or injection molding; produce the neck region of the liner. The conical angled-out section of the plastic neck is produced in a heated post-molding procedure, such as hot gas, heat gun, heated metal, electrical heating, or a non-heated compression method to permanently form the plastic to the shape of the beveled section of the polar boss. Pressure seals are located in two portions; the cylindrical bore portion and also in the conical end portion.

The polar boss has a bore for placing on the exterior surface of the neck region of the polymer liner. The bore transitions to a conical sealing section which fits against the conical section of the polymer liner. The larger bore of the polar boss has screw threads for engaging with the pressure insert.

The polymer neck region is compressed in two places between the outer polar boss and the pressure insert. The first compression area is in the radial direction along the annulus. An O-ring seal in that area augments the radial compression. The second compression area is in the beveled conical section, where the polymer neck is compressed by screwing the pressure insert tightly into the outer neck polar boss. No O-ring or gasket is needed in this area; however, joint sealing compound may be used to ensure a tight fit.

Screwing a metal pressure insert into the polar boss completes the sealing system. The insert is engaged into the polar boss with enough force to create compression seals in two locations. The polymer liner is compressed between the two metallic components, the polar boss and the pressure insert. The first pressure seal is located in the cylindrical portion of the neck. The second pressure seal is located in the conical seal section of the neck. The metal insert contains an annular bore to allow access to the interior of the pressure vessel. The metal insert also has a tapered exterior bore to provide positive compression of the polymer liner against the polar boss.

In a first aspect, a sealing system for an outlet of a polymer-lined compressed gas cylinder is provided having a polymer liner and a structural composite fiber material, the sealing system including: a polar boss having a bore in communication with an interior of the cylinder, the polar boss having a flange shoulder formed on an outer portion of the polar boss for contacting the structural composite material of the gas cylinder, an inner cylindrical neck portion formed on an inner surface of the one or more polar bosses, and a beveled conical section formed on an inner surface of the polar boss adjacent the inner cylindrical neck portion; a neck outlet of the polymer liner extending axially into the bore of the polar boss to form a profiled bore, the profiled bore forming a cylindrical neck region that bends outward to a beveled conical shape that substantially conforms to the inner cylindrical neck and beveled conical section of the polar boss; a pressure insert shaped to fit within and engage with the one or more polar bosses, wherein when the pressure insert is engaged with the polar boss the neck outlet of the polymer liner is secured between an outer surface of the pressure insert and inner cylindrical neck portion of the polar boss, and wherein the neck outlet of the polymer liner is secured between an outer surface of the pressure insert and the beveled conical section of the polar boss.

In one embodiment, the cleaning system further includes an annular recess formed on an outer surface of the pressure insert and an O-ring and backer ring located in the annular recess positioned axially between the pressure insert and the neck outlet of the polymer liner.

In another embodiment, the pressure insert is threadably engaged with the polar boss.

In yet another embodiment, the pressure insert has a tapered interface in the form of a truncated frustum of a right circular cone for compressing the neck outlet of the polymer liner against the polar boss in a radial direction.

In one embodiment, the beveled conical sealing surface of the pressure insert is flat planar such that the polymer liner neck is compressed evenly through beveled conical region.

In another embodiment, the beveled conical sealing surface of the polymer liner neck is covered with a gasket material selected from the group consisting of a metallic gasket, nonmetallic gasket, or viscoelastic joint sealing compound.

In yet another embodiment, the beveled conical sealing surface of the pressure insert is formed with one or more steps, wherein the neck outlet of the polymer liner is subjected to concentrated point loads at each step.

In one embodiment, the beveled conical sealing surface of the polar boss is formed with steps or ridges to that the polymer liner neck is subjected to concentrated point loads at each step.

In another embodiment, the outer neck surface of the polymer liner is substantially smooth with no external threads along a portion where the polymer liner interfaces with the polar boss.

In yet another embodiment, the outer neck surface of the polymer liner includes external screw threads that engage with internal screw threads of the polar boss.

In one embodiment, the liner neck outlet is secured to the bore of the polar boss by a metal-plastic bonding adhesive.

In another embodiment, the liner is selected from the group consisting of a monolayer structure and a multi-layer structure.

In yet another embodiment, the liner neck outlet is coupled to the bore of the boss by a threaded interface.

In one embodiment, the polymer-lined cylinder includes a compressed gas at a working pressure of up to 110 MPa.

In another embodiment, the compressed gas is selected from the group consisting of compressed natural gas (CNG), liquefied petroleum gas (LPG), hydrogen, helium, methane, air, and nitrogen.

In yet another embodiment, the insert is selected from one of a flow through type and plug type insert.

In one embodiment, the polar boss and the pressure insert are formed of a metal.

In another embodiment, the polymer liner is made from a gas compatible polymer selected from the group consisting of HDPE, LDPE, XDPE polyethylene, polyamide 6 and polyamide 12.

In a second aspect, a method for servicing a sealing system of an outlet of a polymer-lined compressed gas cylinder is provided. The cylinder includes a polymer liner and a boss, the boss having a bore for accessing the cylinder that is sealed with an insert. The method includes: disengaging the insert from the outlet of the cylinder to expose a profiled bore of a liner outlet extending axially into the bore of the boss; replacing an annular seal element, the seal element located about an outer surface of the insert, the seal element sealably engaging with the profiled bore; replacing a gasket material in a conical bevel region of the seal; and refurbishing at least one sealing surface located on the profiled bore.

In one embodiment, the refurbishing further comprises refurbishing a cylindrical, sealing bore portion of the profiled bore which normally seals with the element.

In another embodiment, the profiled bore comprises a beveled conical portion, cylindrical sealing bore portion, and tapered bore portion, the refurbishing further comprises: refurbishing the bevel conical portion that seals with a gasket or other sealing material; refurbishing the sealing bore portions that seals with the seal element; and refurbishing the tapered bore portion that engages a tapered compression surface on the insert.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIGS. 1 and 1A are a partial cross-sectional view of a polymer-lined, fiber-wrapped cylinder according to one embodiment, the polar boss on one of both ends being fit over the neck of the polymer liner and with a plug-type of metallic insert that compresses the polymer liner against the polar boss.

FIG. 1B is an exploded view of the polar boss of FIGURE la fit with the metallic pressure insert, the insert shown prior to engagement with the boss and the liner outlet shown prior to engagement with the boss. The liner outlet is molded as a straight neck. The beveled outer sealing section is created using a heated post-molding operation, such as hot gas, heat gun, heated metal, electrical heating, or a non-heated compression method to permanently form the plastic to the shape of the beveled section of the polar boss.

FIG. 2 is an enlarged view of the polar boss assembly of FIG. 1 fit with a metallic pressure insert, O-ring seal, and optional joint sealing compound. In this instance, the beveled conical sealing section is linear.

FIG. 3 is an enlarged view of the polar boss assembly of FIG. 1 fit with a metallic pressure insert, O-ring seal, and optional joint sealing compound. In this instance, the beveled conical sealing section is non-linear with “waves” or “steps” to increase compression at certain points.

FIGS. 4 and 4a are enlarged views of the polar boss assembly of FIG. 2 fit with a metallic pressure insert, O-ring seal and backing ring, and optional joint sealing compound. In this instance, the beveled conical sealing section is linear.

FIG. 4B is an enlarged view of the O-ring and backing ring seal, which provide sealing in the radial direction. The neck of the polymer liner, the O-ring and backing ring are compressed in the radial direction between the outer polar boss and pressure insert.

FIGS. 5, 5a and 5b are enlarged views of the beveled conical compression seal area. The neck of the polymer liner was formed in the conical shape by a heated post-molding process, such as hot gas, heat gun, heated metal, electrical heating, or a non-heated compression method to permanently form the plastic to the shape of the beveled section of the polar boss. The neck of the polymer liner is compressed between the outer neck polar boss and the pressure insert, which forms a tight seal against inner gas pressure. In this embodiment, the bevel seal section of the polar boss and insert are flat planar (appear linear in the figures).

FIGS. 5 and 5b show the use of an optional gasket material such as joint sealing compound. FIG. 5a shows the assembly without use of the optional gasket material.

FIGS. 5c and 5d are enlarged views of the beveled conical compression seal area. In these two embodiments, the bevel seal section of the polar boss and insert are having ridges (non-linear) to allow point loading compression.

FIG. 6 is an isometric view of one embodiment of an outer polar boss;

FIG. 6A and 6B are side and cross-sectional views respectively of a form of polar boss;

FIG. 7 is a partial cross-sectional view of the polymer liner and liner outlet compatible with a boss such as that of FIGS. 1 through 6. The liner outlet is formed in a neck form during conventional molding processes. The outlet is formed to the conical outlet through a heated post-molding process, such as hot gas, heat gun, heated metal, electrical heating, or a non-heated compression method to permanently form the plastic to the shape of the beveled section of the polar boss.

FIG. 8 is an isometric view of the flow-through type pressure insert according to FIGS. 1b and 2. In this embodiment, the conical bevel-sealing surface is planar (linear cross-section).

FIGS. 8a and 8b are side and cross-sectional views respectively of the pressure insert of FIG. 8. In this embodiment, the conical bevel-sealing surface is planar (linear cross-section).

FIG. 9 is an isometric view of the flow-through type pressure insert according to FIGS. 1b and 2. In this embodiment, the conical bevel-sealing surface has ridges for increased “point-load” compression (nonlinear cross-section).

FIGS. 9a and 9b are side and cross-sectional views respectively of the pressure insert of FIG. 9. In this embodiment, the conical bevel-sealing surface has ridges for increased “point-load” compression (nonlinear cross-section).

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

Embodiments of the present disclosure are directed to a sealing system for an outlet of a polymer lined cylinder or pressure vessel for compressed gas. The pressure vessel comprises a polymer liner having a liner outlet and a metallic polar boss plus metallic pressure-sealing insert coupled with the liner outlet. The pressure insert has a bore for accessing the cylinder interior. The polar boss and pressure insert are designed to compress the outlet of the polymer liner in two directions; radially in one region and a conical bevel seal in a second region.

For storage of compressed gas, the liner is supported against bursting using an overlying structure of reinforcing fibers such as carbon fiber, aramid, glass, or basalt. The polymer liner and polar boss are reinforced in a full wrap pattern with structural fibers to provide the necessary structural integrity. The polymer liner, the metallic polar boss and pressure insert are integrated into the composite pressure vessel by the fiber wrapping

The composite pressure vessel, also known as a composite gas cylinder, is designed to store gases such as LPG, nitrogen, air, carbon dioxide (CO2), methane, compressed natural gas (CNG), helium, or hydrogen. Typical working pressures for this type of pressure vessel range from 1.5 to 11.0 MPa.

The polymer liner is composed of a relatively impermeable polymer material. Such polymer material might be HDPE, XDPE, HDPE cross-link, LLDPE, polyurethane, polycarbonate, polyamide 6 (nylon 6), polyamide 12 (nylon 12), PET, ABS, multiple layer PE+EVOH, and similar polymers.

The metallic polar boss and pressure-sealing insert might be made of 6061-T6, 7075-T6 or similar aluminum alloys, 4351 or similar steel alloys, and/or 316, 303 or similar stainless steels.

The composite fiber overwrap might be made of inorganic or organic structural fibers such as carbon fiber, aramid, glass, basalt, or zylon fibers. The fibers might be impregnated with a matrix material such as epoxy, polyester, vinyl ester, polyurethane, or some thermoplastic materials.

The polymer liner neck outlet extends axially into a bore of the polar boss to form a profiled bore section which transitions to an angled conical section. The neck portion of the polymer liner is first formed into a bore neck using conventional molding techniques such as rotational molding, blow molding, injection molding, or similar. The beveled conical seal section is formed in post-molding operations, which might be machining, heated forming, slow compression, or some other method.

The result is a bi-directional pressure seal system with pressure seals in two directions and two locations. The first location is in the annular bore section of the neck and polar boss. The second pressure seal is located in the angular conical section.

A metallic pressure-sealing insert is engaged into the metal polar boss to provide compression of the two pressure seal locations. The metallic pressure insert has a corresponding profiled surface to match the outer polar boss, the outlet neck region of the polymer liner, and the O-ring and backing ring. When the insert is engaged with the polar boss, one annular primary seal is formed in the radial direction by compressing the plastic neck, O-ring and backing ring against the annular opening of the outer polar boss. A second primary seal is formed between the beveled conical sections of the polar boss, polymer liner and pressure insert. An optional gasket material might be used in the bevel compression section, such as joint sealing compound or a polymer or metallic bevel gasket.

In one embodiment, the beveled conical compression sections of the polar boss and pressure insert are flat planar (linear cross-section). The beveled conical section of the polymer liner is compressed evenly across the width.

In another embodiment, the beveled conical compression sections of the pressure insert and/or polar boss are built with ridges (stepped or wavy cross section). The beveled conical section of the polymer liner is highly compressed in localized regions of the compression seal area.

In another embodiment, the pressure insert is built with a taper of the outer surface of the annular region, creating a tight compression through the full cylindrical neck region of the polymer liner. This extra compression closes any annular assembly clearance to block extrusion of the O-ring or similar pressure ring seal assembly at high pressures. The extra compression is tight enough through the complete cylindrical section of the neck that the O-ring becomes redundant.

The bi-directional, two location seal system with compression in two locations and two directions provides infallible pressure sealing of small-molecule gases such as helium or hydrogen at pressures up to 110 MPa.

The bi-direction, two-location compression method seals high-pressure gases even if the O-ring has a flaw or other malfunction. If there is a flaw or malfunction of the pressure seal, it is easy to disassemble and repair the neck polar boss assembly.

Bi-directional compression of the liner neck material minimizes creep of the sealing surfaces otherwise susceptible to sustained sealing element and pressure loads. This system also minimizes the effects of thermal expansion and contraction due to high and low temperature extremes.

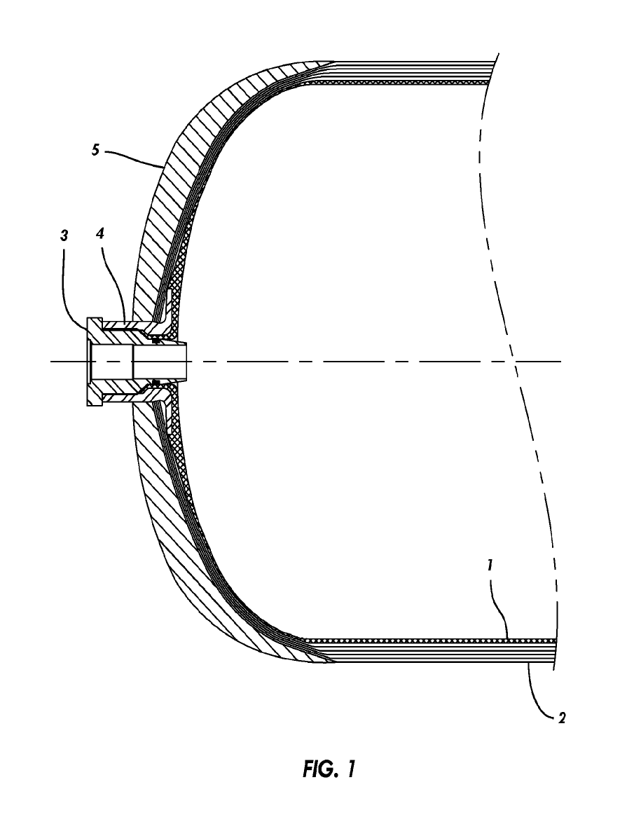

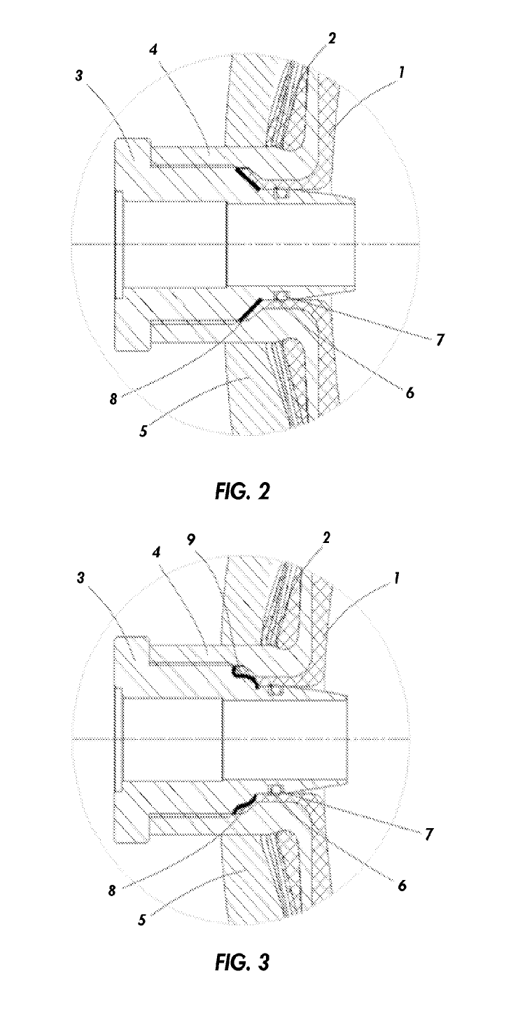

FIGS. 1 to 9 illustrate an embodiment of the sealing system as part of a high pressure, fully wrapped, polymer lined composite pressure vessel. The embodiments shown in FIGS. 1 to 9 are suitable for use with the storage of conventional gases such as LPG, air, nitrogen, methane, compressed natural gas (CNG), carbon dioxide (CO2), helium and hydrogen at working pressures up to 110 MPa.

With reference to FIGS. 1 and 1a, a polar dome of a polymer liner 1 of a polymer-lined, compressed gas cylinder is reinforced with full wrap fibers plus matrix material 2. This type of pressure vessel is known as a composite pressure vessel or composite gas cylinder. A neck region of the polymer liner 1 is fitted with a rigid metal polar boss 4 and a pressure-sealing insert 3 that includes a bore for accessing an interior of the gas cylinder. The dome region is protected from impact damage by a protective outer cap 5. The polar boss 4 is fixed to the polymer liner 1 prior to wrapping the structural fibers/matrix material 2. The pressure insert 3 is engaged into the polar boss 4 before and/or after wrapping the structural fibers 2. The polymer liner 1 is formed to a cylindrical neck region and an outer bevel conical section. The outer bevel conical section of the polymer liner 1 is typically formed to shape after affixing the polar boss 4. When the pressure insert 3 is inserted and engaged fully to the polar boss 4, the polymer liner 1 is compressed in two directions and two locations; radial compression in the cylindrical neck region, and beveled conical compression in the bevel region. The two-direction, two-location compression forms a very safe seal against high-pressure gases.

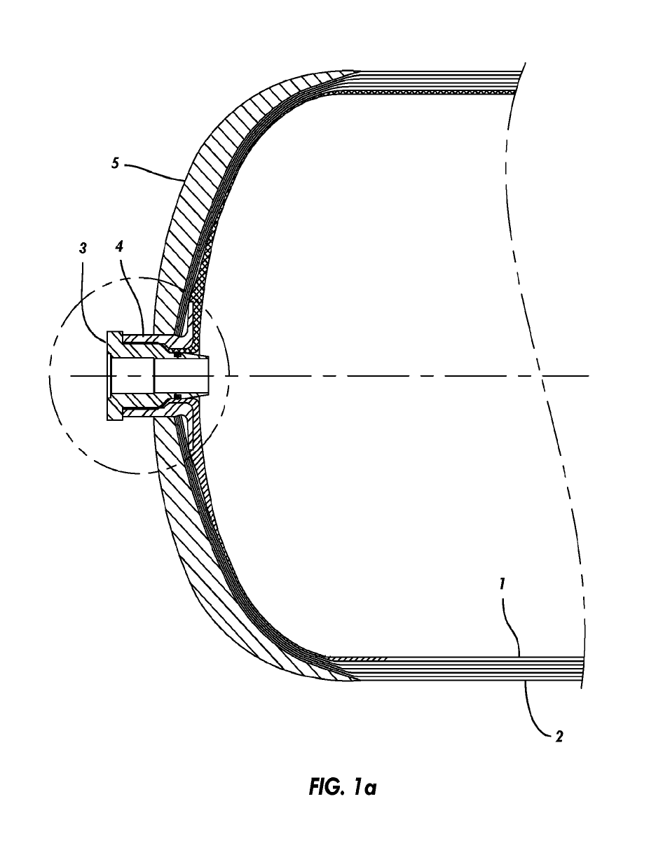

As shown in FIGS. 1b and 2, the pressure insert 3 has a generally cylindrical body which includes an external, threaded portion which engages with the internal, threaded portion of the boss 4 for reversible coupling the insert 3 with the boss 4. The polar boss 3 is inserted over and fixed to the neck of the polymer liner 1 before wrapping the structural fibers 2. The neck of the polymer liner 1 is formed after conventional molding and after insertion into the polar boss 4 to form a bevel conical outer section. This shape allows compression of the polymer liner 1 between the polar boss 4 and pressure insert 3 in two directions and two locations. An O-ring seal 6 and backing ring 7 or similar gasket might be used to provide additional pressure sealing in the radial direction. An additional gasket material 8 in the bevel conical section might be used, such as a metallic or nonmetallic gasket material or joint sealing compound (FIG. 2). However, it is to be understood that elements 6, 7, and 8 may be optional.

FIGS. 2, 4, 4a, 5, 5a, and 5b show an embodiment where the pressure seal insert 3 has a flat planar shape of the bevel conical seal section (linear cross section). The polymer neck bevel section 1 is compressed equally between the planar surfaces of the polar boss 4 and pressure insert 3. An optional gasket material 8 may be used in the interface between the polymer liner 1 and the pressure insert 3.

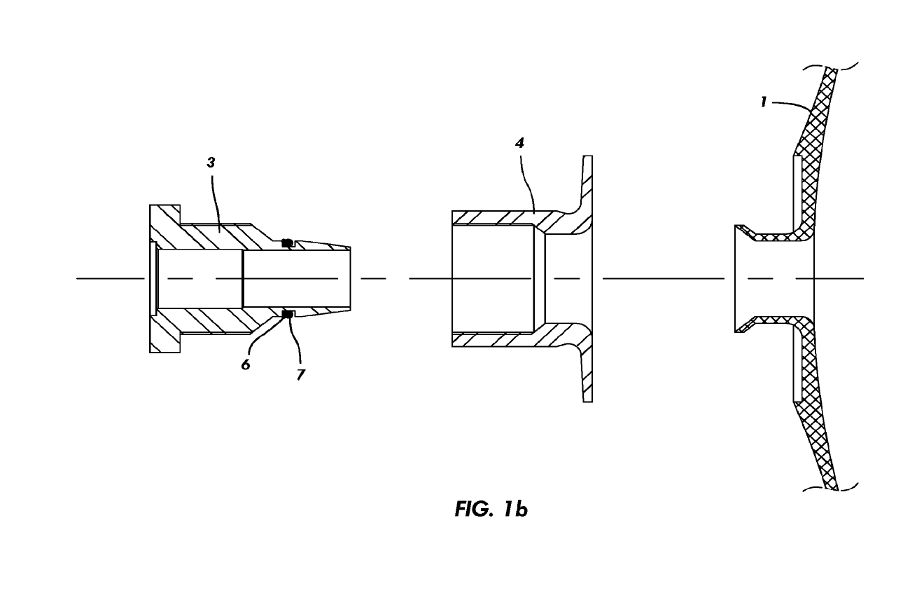

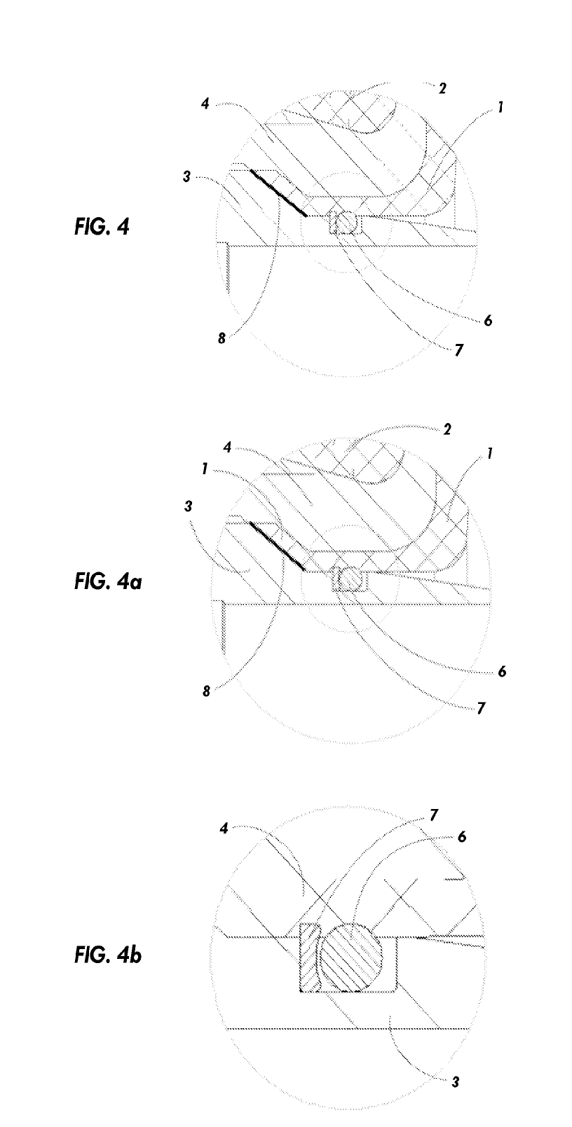

FIGS. 3, 5c, and 5d show an embodiment where the pressure seal insert 3 and/or the polar boss 4 have a wavy or stepped shape of the bevel conical seal section. The polymer neck bevel section 1 is compressed highly in “points” between the conical surfaces of the polar boss 4 and pressure insert 3. An optional gasket material 8 may be used in the interface between the polymer liner 1 and the pressure insert 3.

FIGS. 2, 3, 4, 4a, 4b, and 5 show an embodiment where an O-ring 6 and backing ring 7 are used to provide additional compression sealing in the radial direction between the pressure insert 3, polymer liner neck 1, and polar boss 4. The O-ring 6 and backing ring 7 may be an elastomeric or polymeric material such as nitrile, Viton, or other common pressure sealing material. The O-ring 6 and the backing ring 7 are optional and may be excluded for certain gases or pressures.

FIGS. 1b, 2, 3, 4, 4a, 4b, and 5 illustrate an embodiment including a taper angle that is built into the outer bore of the pressure seal insert 3. The taper angle is designed to force the neck of the polymer liner 1 outward against the bore of the polar boss 3. The result is high compression of the liner 1 between the polar boss 4 and pressure insert 3. With this compression feature, the O-ring 6 and backing ring 7 often become redundant. This region can often contain high-pressure gases even if there is a malfunction of the O-ring 6 and/or backing ring 7.

As a result, a simple and reliable bidirectional pressure sealing system or arrangement is achieved.

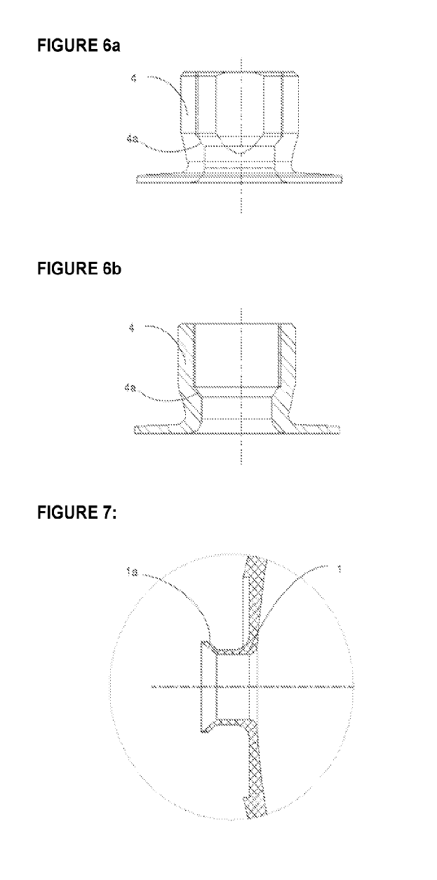

In one embodiment of the polymer liner 1 as shown in FIGS. 1, 1a, 1b, and 7, the liner 1 is a relatively impermeable bladder of polyamide 6, HDPE, or cross-linked HDPE which are suitable for most gases. The thickness typically ranges from 2 to 10 mm. The cylindrical surface of the liner outlet neck 1 might be smooth or it might have external threads to facilitate assembly with the polar boss 4. The outer diameter of the liner outlet neck 1 might range from 18 to 50 mm diameter. The beveled conical outlet section of the polymer liner 1 is typically formed after assembly with the outer polar boss 4 and before insertion of the pressure insert 3.

In another embodiment of the liner, the polymer liner 1 could include a supplemental layer of EVOH EVAL F101B for improved resistance to gas permeation, or it could be HDPE or other polyethylene material to reduce costs.

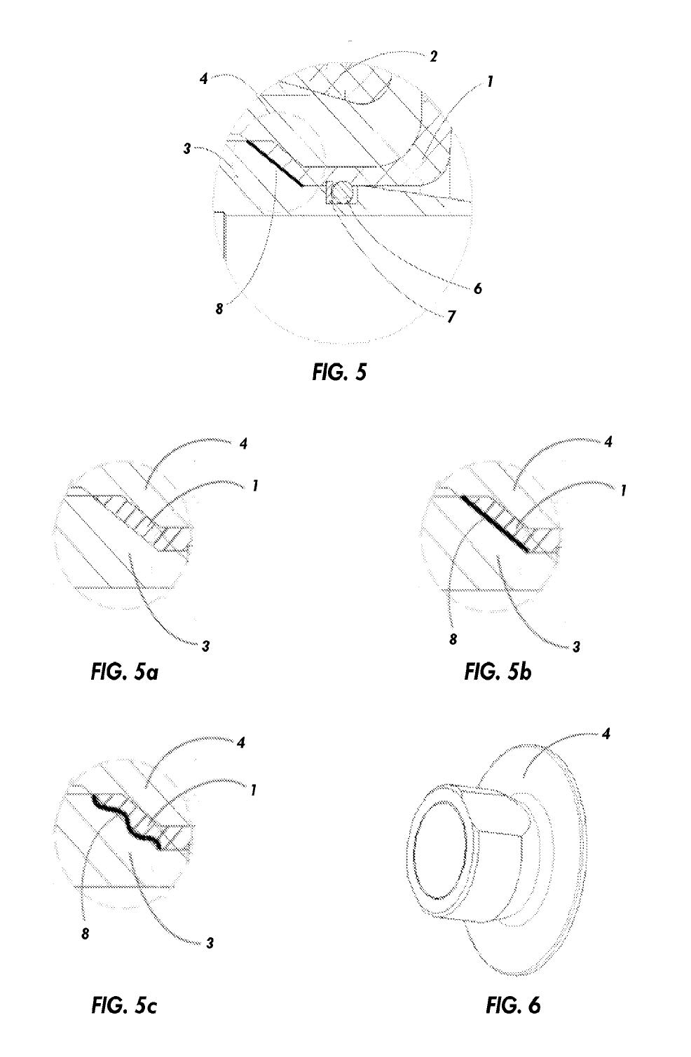

As shown in FIGS. 6, 6a, and 6b, the polar boss 4 is typically formed of an aluminum alloy such as anodized AA6061-T6 or AA7075-T6 or similar, steel alloy such as 4340 or similar, stainless steel such as 316 stainless steel or similar, or brass. After insertion of the liner neck 1, the liner neck may be fixed to the polar boss 4 through the use of adhesive bonding or with screw threads, mating external screw thread on the liner neck 1 to internal screw threads in the polar boss 4.

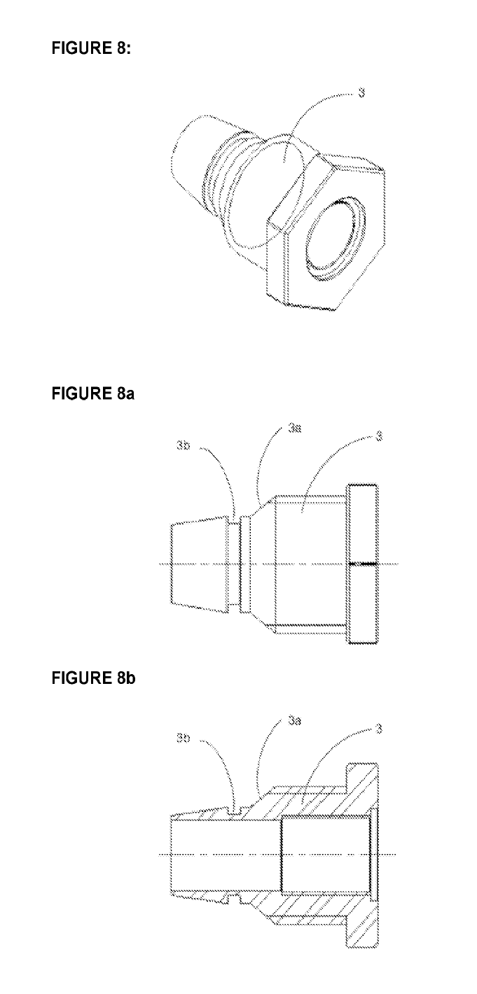

FIGS. 8, 8a, and 8b show an embodiment of the pressure insert 3 with flat planar beveled conical sealing surface. The pressure insert is typically formed of aluminum alloy such as anodized AA6061-T6 or AA7075-T6 or similar, steel alloy such as 4340 or similar, stainless steel such as 316 stainless steel or similar, or brass.

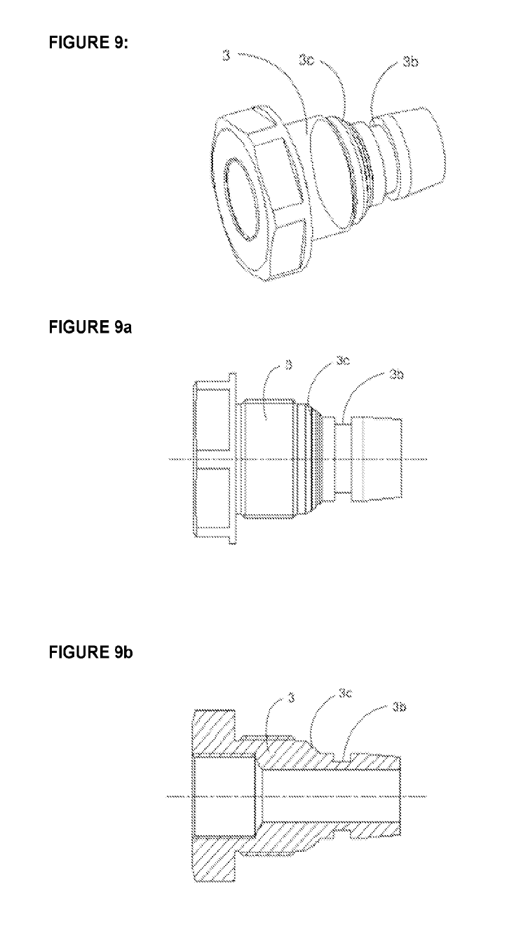

FIGS. 9, 9a, and 9b show an embodiment of the pressure insert 3 with stepped or ridged beveled conical sealing surface. The pressure insert is typically formed of aluminum alloy such as anodized AA6061-T6 or AA7075-T6 or similar, steel alloy such as 4340 or similar, stainless steel such as 316 stainless steel or similar, or brass.

Differential thermal expansion of the differing materials at the outlet can be minimized. Differential thermal expansion can occur as the polymer material of the liner neck outlet 1 has a higher co-efficient of thermal expansion (CTE) than that the material of the boss 4 and pressure insert 3. In both embodiments of the sealing system, reducing the thickness of liner material in the liner outlet 1 can minimize radial expansion of the liner outlet 1 due to temperature changes. In both embodiments of the sealing system, should a leak develop over time due to deterioration of the O-ring or the two primary sealing surfaces on the liner outlet 1 or the sealing surface on the insert 3, the liner outlet or insert sealing surfaces can be serviced or repaired. This is possible as the liner outlet 1 extends into the bore of the boss 4 and can be easily accessed for repair or service. As the O-ring is located on the insert 3 and since the insert 3 can be disengaged from the boss 4, the O-ring 6 and backing ring 7 can also be easily replaced.

Accordingly, a method for servicing the sealing system of FIGS. 1 to 9b is provided. The method comprises disengaging the insert 3 engaged with the liner outlet 1 from the bore of the boss 4 for exposing the profiled liner bore 1. The gasket material 8 in the beveled conical section can be replaced. Additionally, the O-ring 6 and backing ring 7 can also be replaced. All internal sealing surfaces can be inspected, measured, and repaired if necessary.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A sealing system for an outlet of a polymer-lined compressed gas cylinder having a polymer liner and a structural composite fiber material, the sealing system comprising:
a polar boss having a bore in communication with an interior of the cylinder, the polar boss including
a flange shoulder formed on an outer portion of the polar boss for contacting the structural composite material of the gas cylinder,
an inner cylindrical neck portion formed on an inner surface of the one or more polar bosses, and
a beveled conical section formed on an inner surface of the polar boss adjacent the inner cylindrical neck portion;
a neck outlet of the polymer liner extending axially into the bore of the polar boss to form a profiled bore, the profiled bore forming a cylindrical neck region that bends outward to a beveled conical shape that substantially conforms to the inner cylindrical neck and beveled conical section of the polar boss;
a pressure insert shaped to fit within and engage with the one or more polar bosses, wherein when the pressure insert is engaged with the polar boss the neck outlet of the polymer liner is radially compressed between an outer surface of the pressure insert and inner cylindrical neck portion of the polar boss, and wherein the neck outlet of the polymer liner is compressed between an outer surface of the pressure insert and the beveled conical section of the polar boss.

2. The sealing system of claim 1, further comprising an annular recess formed on an outer surface of the pressure insert and an O-ring and backer ring located in the annular recess positioned axially between the pressure insert and the neck outlet of the polymer liner to form a seal at the cylindrical neck portion of the polar boss.

3. The sealing system of claim 1, wherein pressure insert is threadably engaged with the polar boss.

4. The sealing system of claim 1, wherein the pressure insert has a tapered interface in the form of a truncated frustum of a right circular cone for compressing the neck outlet of the polymer liner against the polar boss in a radial direction.

5. The sealing system of claim 1, wherein the beveled conical sealing surface of the pressure insert is flat planar such that the polymer liner neck is compressed evenly through beveled conical region.

6. The sealing system of claim 1, wherein the beveled conical sealing surface of the polymer liner neck is covered with a gasket material selected from the group consisting of a metallic gasket, nonmetallic gasket, or viscoelastic joint sealing compound.

7. The sealing system of claim 1, wherein the beveled conical sealing surface of the pressure insert is formed with one or more steps, wherein the neck outlet of the polymer liner is subjected to concentrated point loads at each step.

8. The sealing system of claim 1 wherein the beveled conical sealing surface of the polar boss is formed with steps or ridges to that the polymer liner neck is subjected to concentrated point loads at each step.

9. The sealing system of claim 1, wherein the outer neck surface of the polymer liner is substantially smooth with no external threads along a portion where the polymer liner interfaces with the polar boss.

10. The sealing system of claim 1, wherein the outer neck surface of the polymer liner includes external screw threads that engage with internal screw threads of the polar boss.

11. The sealing system of claim 1, wherein the liner neck outlet is secured to the bore of the polar boss by a metal-plastic bonding adhesive.

12. The sealing system of claim 1, wherein the liner is selected from the group consisting of a monolayer structure and a multi-layer structure.

13. The sealing system of claim 1, wherein liner neck outlet is coupled to the bore of the boss by a threaded interface.

14. The sealing system of claim 1, wherein the polymer-lined cylinder contains includes a compressed gas at a working pressure of up to 110 MPa.

15. The sealing system of claim 1, wherein the compressed gas is selected from the group consisting of compressed natural gas (CNG), liquefied petroleum gas (LPG), hydrogen, helium, methane, air, and nitrogen.

16. The sealing system of claim 1, wherein the insert is selected from one of a flow through type and plug type insert.

17. The sealing system of claim 1, wherein the polar boss and the pressure insert are formed of a metal.

18. The sealing system of claim 1, wherein the polymer liner is made from a gas compatible polymer selected from the group consisting of HDPE, LDPE, XDPE polyethylene, polyamide 6 and polyamide 12.

19. A method for servicing a sealing system of an outlet of a polymer-lined compressed gas cylinder, the cylinder comprising a polymer liner and a boss, the boss having a bore for accessing the cylinder that is sealed with an insert, the method comprising:
disengaging the insert from the outlet of the cylinder to expose a profiled bore of a liner outlet extending axially into the bore of the boss;
replacing an annular seal element, the seal element located about an outer surface of the insert, the seal element sealably engaging with the profiled bore;
replacing a gasket material in a conical bevel region of the seal; and
refurbishing at least one sealing surface located on the profiled bore.

20. The method of claim 19 wherein the refurbishing further comprises refurbishing a cylindrical, sealing bore portion of the profiled bore which normally seals with the element.

21. The method of claim 20 wherein the profiled bore comprises a beveled conical portion, cylindrical sealing bore portion, and tapered bore portion, the refurbishing further comprises:
refurbishing the bevel conical portion that seals with a gasket or other sealing material;
refurbishing the sealing bore portions that seals with the seal element; and
refurbishing the tapered bore portion that engages a tapered compression surface on the insert.
